(19) United States
(12) Patent Application Publication
(10) Pub. No.: US 2010/0166368 A1
(43) Pub. Date: Jul. 1, 2010

(54) GRATING LIKE OPTICAL LIMITER

(75) Inventors: Ram Oron, Rehovot (IL); Ariela Donval, Rosh-Ha'ain (IL); Boaz Nemet, Tel-Aviv (IL); Doron Nevo, Ra'anana (IL); Moshe Oron, Rehovot (IL)

Correspondence Address: NIXON PEABODY, LLP, 300 S. Riverside Plaza, 16th Floor, CHICAGO, IL, 60606-6613, US

(73) Assignee: KiloLambda Technologies Ltd., Tel-Aviv (IL)

(21) Appl. No.: 12/525,117

(22) PCT Filed: Jan. 31, 2008
(86) PCT No.: PCT/IB08/00219

§ 371 Date: Mar. 3, 2010

Related U.S. Application Data
(60) Provisional application No. 60/898,920, filed on Feb. 1, 2007.

(51) Int. Cl. G02B 6/34; G02B 6/26

(52) U.S. Cl. 385/37; 385/39; 385/31

(57) ABSTRACT

A reversible optical energy limiting device comprises a waveguide forming an optical path between an input end and an output end, and an optical energy responsive material located in the optical path for reflecting at least a portion of optical energy received from the input end back toward the input end when the optical energy exceeds a predetermined threshold. The optical energy responsive material does not reflect optical energy when it drops below the predetermined threshold, and thus propagation of optical energy from the input end to the output end is automatically resumed when the optical energy drops below the predetermined threshold. The optical energy responsive material may extend across the optical path an acute angle relative to the longitudinal axis of the optical path so that back-reflected light does not re-enter the optical system.

### FIELD OF THE INVENTION

The present invention relates to optical power limiting, and more particularly, to an optical power limiting passive device and to a method for limiting optical power transmission.

### BACKGROUND OF THE INVENTION

Optical limiters are devices designed to have high transmittance for low-level light inputs and low transmittance for high power. Since the development of the first lasers, passive optical limiters have been researched and concepts have been tested to protect optical sensors against laser peak-power induced damage. The first optical limiters for CW lasers were based on thermal lensing in absorbing bulk liquids, i.e., local heating in an imaging system reduced the index of refraction, causing “thermal blooming” and resulting in a beam that was no longer focused. Other methods have been suggested for limiting pulsed laser sources such as reverse saturable absorption, two-photon and free carrier absorption, self-focusing, nonlinear refraction and induced scattering. The device itself must also possess a high threshold against damage, and not get into a state where it is “bleached-out” or transparent.

Communications and other systems in medical, industrial and remote sensing applications, may handle relatively optical high powers, from microwatts up to several Watts, in single fibers or waveguides. With high intensities (power per unit area) introduced into these systems, many thin film coatings, optical adhesives, and even bulk materials, are exposed to light intensity beyond their damage thresholds. Another problem is laser safety, wherein there are well-defined upper power limits allowed to be emitted from fibers into the open air. These two issues call for a passive device that will limit the amount of energy propagating in a fiber/waveguide to the allowed level.

There have been many attempts to realize optical limiters, mainly for high power laser radiation, high power pulsed radiation, and eye safety devices. The techniques used in these devices were mainly:
1) Thermal change of the index of refraction n, in liquids having negative dn/dT, for defocusing the light beam, e.g., in an imaging system.
2) Self-focusing or self-defocusing, due to high electric field-induced index of refraction n change, through the third order susceptibility term of the optical material, here n=n₀+n₂E² where n₀ is the index of refraction at zero electric field (no light), n₂ is the non-linear index change and E is the electric field strength of the light beam.
3) Colloidal Suspensions such as carbon black in both polar and non polar solvents which limit by induced scattering.

The first two of the above-mentioned techniques require very energetic laser beams or light intensities to produce a meaningful limitation. In the first technique, the volumes of liquid to be heated are large and need high powers. Another problem with this method is that the liquid is not a good optical medium and distorts the beam. In the second technique, the n₂ coefficient is very small for usable materials and requires very high electric fields.

In the third method, the use of liquids is problematic for most applications. In a communications system, for instance, the use of liquids in a passive device causes noise and distortion from turbulence of the liquid in the optical path. Other problems reported using the colloidal liquid as an optical limiting medium include aging either by disappearance of the active carbon material or the formation of flocks of loosely bound carbon particles that breakup only after ultrasonic deflocculation. Some work has been done on using liquid crystals as limiting material, mainly for high power pulses but these materials cause noise and distortion worse than ordinary liquids due to director fluctuations.

### SUMMARY OF THE INVENTION

In one embodiment, a reversible optical energy limiting device comprises a waveguide forming an optical path between an input end and an output end, and an optical energy responsive material located in said optical path for reflecting at least a portion of optical energy received from the input end back toward the input end when the optical energy exceeds a predetermined threshold. The optical energy responsive material does not reflect optical energy when it drops below the predetermined threshold, and thus propagation of optical energy from the input end to the output end is automatically resumed when the optical energy drops below the predetermined threshold. The optical energy responsive material may extend across the optical path an acute angle relative to the longitudinal axis of the optical path so that back-reflected light does not re-enter the optical system. In one implementation, the optical energy responsive material comprises an optical power limiting grating which undergoes reversible thermal changes when subjected to optical energy above said predetermined threshold. The grating may comprise multiple layers of transparent dielectric material, where alternating layers are totally transparent, and intervening layers include small light absorbing particles dispersed in an optically transparent matrix material. Alternatively, the grating may comprise alternating layers of transparent dielectric material, and intervening layers of a thin, nanometer-thickness, partially-light-absorbing material in an optical system of limited numerical aperture.

One embodiment provides a method for limiting the power transmitted at a focal point of a lens or mirror in an optical system, inside a waveguide or in a gap between waveguides, where an optical limiting solid grating is placed.

The optical power-limiting device has the capability of providing the following advantages and properties:
1. The operation of the limiter is passive; no external power is required.
2. The device operates for many (e.g., thousands) cycles, limiting at high input powers and returning to its original, non-limiting state when the input power is lowered or shut off.
3. The device may be activated by a wide range of wavelengths, (e.g., visible, 800, 980, 1065, 1310, 1550 nm). Small differences in materials and dimensions enable the device to fit the right spectral range.
4. The device withstands high intensities a few (e.g., 10) times higher than the limiting threshold.
5. The device has, relatively, fast (e.g., in the microseconds region and below) response, limited by the indirect heating time of minute volumes.
6. The device has high spectral transmission (e.g., 1-2 dB insertion loss) at intensities well below the power limit.
7. The device is suitable for use as an in-line fiber insert (like a patch cord), for single or multi-mode fibers, or for fiber lasers and for free space uses.
8. The device enables the implementation for low power optical limiters.

Some uses of the limiter may be in the optical communication area, e.g., detector protection, switch and line protection, amplifier input signal limiting and equalizing and power surge protection. Also, power regulation in networks, in the input or at the output from components. In the areas of medical, military and laser machining, e.g., an optical power limiter can be used for surge protection and safety applications. If used as a protective device in an imaging system, the limiter will work at the image point where there appears a bright light or a laser source and limit the amount of incoming light from this source without interfering with the rest of the image.

### BRIEF DESCRIPTION OF THE DRAWINGS

The invention will be better understood from the following description of preferred embodiments together with reference to the accompanying drawings, in which:

FIG. 1 is a cross-sectional view of two waveguide sections and an optical limiting solid grating, type 1, perpendicular to the beam propagation direction, constituting optical power limiting devices;

FIG. 2 is a cross-sectional view of two waveguide sections and an optical limiting solid grating, type 1, angled to the beam propagation direction, constituting optical power limiting devices;

FIG. 3 is a cross-sectional view of two waveguide sections and an optical limiting solid grating, type 2, perpendicular to the beam propagation direction, constituting optical power limiting devices;

FIG. 4 is a cross-sectional view of two waveguide sections and an optical limiting solid grating, type 2, angled to the beam propagation direction, constituting optical power limiting devices;

FIG. 5 is a cross-sectional view of two lens sections and an optical limiting solid grating, type 1 or 2, perpendicular to the beam propagation direction, constituting optical power limiting devices, in free space;

FIG. 6 is a cross-sectional view of two lens sections and an optical limiting solid grating, type 1 or 2, tilted to the beam propagation direction, constituting optical power limiting devices, in free space;

FIG. 7 is a cross-sectional view of an optical limiting solid grating, type 1 or 2, in front of a camera, perpendicular to the beam propagation direction;

FIG. 8 is an illustration of three kinds of gratings.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

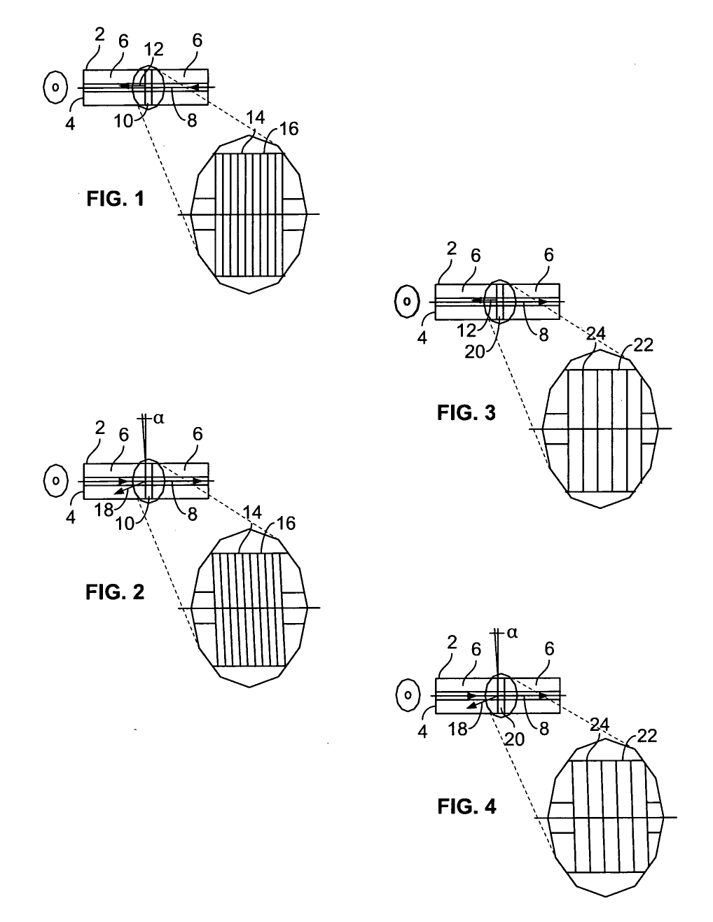

Turning now to the drawings, FIGS. 1-4 illustrate optical limiter configurations using power-limiting gratings of two types. The first type is an optical limiting solid grating comprising multiple layers of transparent dielectric material, where alternating layers are totally transparent, and intervening layers include a mixture of light absorbing particles. The second type is an optical limiting solid grating comprising alternating layers of totally transparent dielectric material, and intervening layers of a thin, nanometer-thickness, partially-light absorbing material.

In the first type of grating (Type 1), the light absorbing particles are smaller than the wavelength of visible light (smaller than 0.5 microns) and preferably smaller than 0.1 microns (nano-powder), and are dispersed in a solid dielectric matrix material. The process of limiting starts by light absorption in the dispersed powder particles, each according to its absorption spectrum. When the particles are heated by the absorbed light, they conduct heat to their surroundings, creating alternating layers having different indices of refraction and influencing the amount of the back scattered radiation. Positive or negative dn/dT creates similar effects in the back scattering or reflection. The back reflected light reduces the forward component, thus limiting the forward light flux. When the incident power is reduced, the heated volume that surrounds each absorbing particle diminishes. The transmittance through the optical limiting solid mixture returns to its original value, and the scattering process decreases to negligible values. The process may be repeated many times without any permanent damage up to energies that are an order of magnitude or more, larger than the transmitted power limit.

The second type of grating (Type 2) comprises alternating layers of totally transparent dielectric material, and intervening layers of a thin, nanometer-thickness, partially absorbing layer. The material of each transparent layer is an optical polymer or inorganic glass material, preferably at least one material selected from the group consisting of PMMA (Poly Methyl Methacrylate), derivatives of PMMA, epoxy resins, silicone elastomers, glass, SOG (Spin-On Glass), other sol-gel materials and other transparent host materials. Each partially absorbing layer has a thickness much smaller than the wavelength of visible light and preferably few (e.g., 1 to 10) nanometers thick (nano-layer). The material of the light absorbing layer is preferably at least one material selected from the group consisting of Ag, Au, Ni, Va, Ti, Co, Cr, C, Re, Si, SmO₂ and mixtures of these or other light absorbing nano-layers. The process of limiting starts by light absorption in the partially absorbing layers, according to their absorption spectrum. When these layers are heated by the absorbed light, they conduct heat to their surroundings, creating, due to the temperature gradients, alternating layers having different indices of refraction and influencing the amount of the back reflected and scattered radiation. Positive or negative dn/dT creates similar effects in the back scattering or reflection. The back reflected light reduces the forward component, thus limiting the forward light flux. When the incident power is reduced, the heated volume that surrounds each absorbing layer diminishes. The transmittance through the optical limiting solid mixture returns to its original value, and the scattering and reflection process decreases to negligible values. The process may be repeated many times without any permanent damage up to energies that are an order of magnitude or more larger than the transmitted power limit.

The first type of grating involves the preparation of dispersed particles in a transparent matrix such as monomer, which is subsequently polymerized. There are many techniques for preparing such dispersions, such as with the use of dispersion and deflocculation agents added to the monomer mix. One trained in the arts of polymer and colloid science is able to prepare this material for a wide choice of particles and monomers. Similarly, techniques are well known in the prior art to prepare composite materials with dispersed sub-micron particles in inorganic glass matrices.

The second type of grating involves the preparation of alternating layers of thin partial absorber and intervening transparent layers such as glass or polymer. There are many techniques for preparing such alternating layers, e.g., by using thin film deposition techniques.

FIG. 1 illustrates a grating-like optical limiter configuration, using a Type 1 limiter perpendicular to the beam propagation direction. Light enters a fiber or waveguide 2 having a core 4 and a cladding 6 (e.g., SMF 28 by Corning, USA), and impinges on an optical limiting solid grating 10 placed at the exit of core 4. The grating 10 includes alternating layers 14 and 16 of transparent dielectric material, where one kind of layer 16 is totally transparent and the other kind of layer 14 includes some mixture of light absorbing particles. The light absorbing particles are smaller than the wavelength of visible light (smaller than 0.5 microns), preferably smaller than 0.1 microns (nano-powder), dispersed in a solid dielectric matrix material. The light absorbing particles comprise at least one metallic or non-metallic material selected from the group consisting of: Ag, Au, Ni, Va, Ti, Co, Cr, C, Re, Si, SmO₂ and mixtures of these or other metallic or semiconductor particles or quantum dots or rods. The solid matrix material may be a transparent or optical polymer or inorganic glass material (e.g., PMMA (Poly Methyl Methacrylate) and its derivatives, epoxy resins, silicone elastomers, glass, SOG (Spin On Glass), or other sol-gel materials and any other transparent host material).

The process of limiting starts by light absorption in the dispersed powder particles of layers 14, each according to its absorption spectrum. When the particles are heated by the absorbed light, they conduct heat to their surroundings, creating alternating layers 14 and 16 having different indices of refraction (high index-low index etc.) and influencing the amount of the back reflected and scattered radiation 12. Positive or negative dn/dT materials create similar effects in the back scattering or reflection 12. The back reflected light reduces the forward component 8, thus limiting the forward light flux. When the incident power is reduced, the heated volume that surrounds each absorbing particle diminishes. The transmittance through the optical limiting solid grating 10 returns to its original value, and the reflection and scattering process decreases to negligible values. The process may be repeated many times without any permanent damage up to energies that are an order of magnitude or more larger than the transmitted power limit. This limiter functions well on the forward direction, and limits the output light 8, but the back reflected light can be troublesome.

FIG. 2 illustrates a variation of the embodiment shown in FIG. 1 in which the optical limiting Type 1 grating 10 is placed at an angle so that reflected light from the limiting grating 10 does not re-enter the optical system. The limiter is placed not perpendicular to the beam propagation direction, but at an angle α. Light enters the fiber or waveguide 2 having a core 4 and cladding 6 (e.g., SMF 28 by Corning, USA), and impinges on the optical limiting solid grating 10 placed at the exit of core 4. The optical limiting solid grating 10 is angled and not perpendicular to the beam propagation direction, having an angle α, typically 8 degrees, directing the reflected beam 18 out of the core 4 and into the cladding 6 where it does not propagating back.

FIG. 3 illustrates a grating like optical power limiting device using a Type 2 limiter, perpendicular to the beam propagation direction. Light enters fiber or waveguide 2 having a core 4 and cladding 6 (e.g., SMF 28 by Corning, USA) and impinges on an optical limiting solid grating 20 placed at the exit of core 4. The grating 20 includes alternating layers of transparent dielectric material 22 and a thin, nanometer-thickness, partially absorbing layer 24 having a thickness much smaller than the wavelength of visible light and preferably a few (e.g., 1 to 10) nanometers thick (nano-layer). The light absorbing layer may comprise at least one metallic or non-metallic material selected from the group consisting of Ag, Au, Ni, Va, Ti, Co, Cr, C, Re, Si, SmO₂ and mixtures of these or other light absorbing nano-layers metallic or semiconductor layers. The transparent layer is a transparent optical polymer or inorganic glass material (e.g., PMMA (Poly Methyl Methacrylate) and its derivatives, epoxy resins, silicone elastomers, glass, SOG (Spin On Glass), or other sol-gel materials and any other transparent host material).

The process of limiting starts by light absorption in the partially absorbing layer, according to its absorption spectrum. When particles in this layer are heated by the absorbed light, they conduct heat to their surroundings, creating, due to the temperature gradients, alternative layers having different indices of refraction and influencing the amount of the back reflected and scattered radiation. Positive or negative dn/dT creates similar effects in the back scattering or reflection. The back reflected light reduces the forward component, thus limiting the forward light flux. When the incident power is reduced, the heated volume that surrounds each absorbing layer diminishes. The transmittance through the optical limiting solid mixture returns to its original value, and the scattering and reflection process decreases to negligible values. The process may be repeated many times without any permanent damage up to energies that are an order of magnitude or more larger than the transmitted power limit. This limiter functions well on the forward direction and limits the output light 8, but the back reflected light may be troublesome.

FIG. 4 illustrates a variation of the embodiment shown in FIG. 3 in which the Type 2, optical limiting grating 20 is placed at an angle so that reflected light from the limiting grating 20 does not re-enter the optical system. Light enters fiber or waveguide 2 having a core 4 and a cladding 6 (e.g., SMF 28 by Corning, USA), and impinges on the grating 20 placed at the exit of core 4. The grating 20 is angled and not perpendicular to the beam propagation direction, having an angle α, typically 8 degrees, directing the reflected beam 18 out of the core 4 and into the cladding 6 where it does not propagate back.

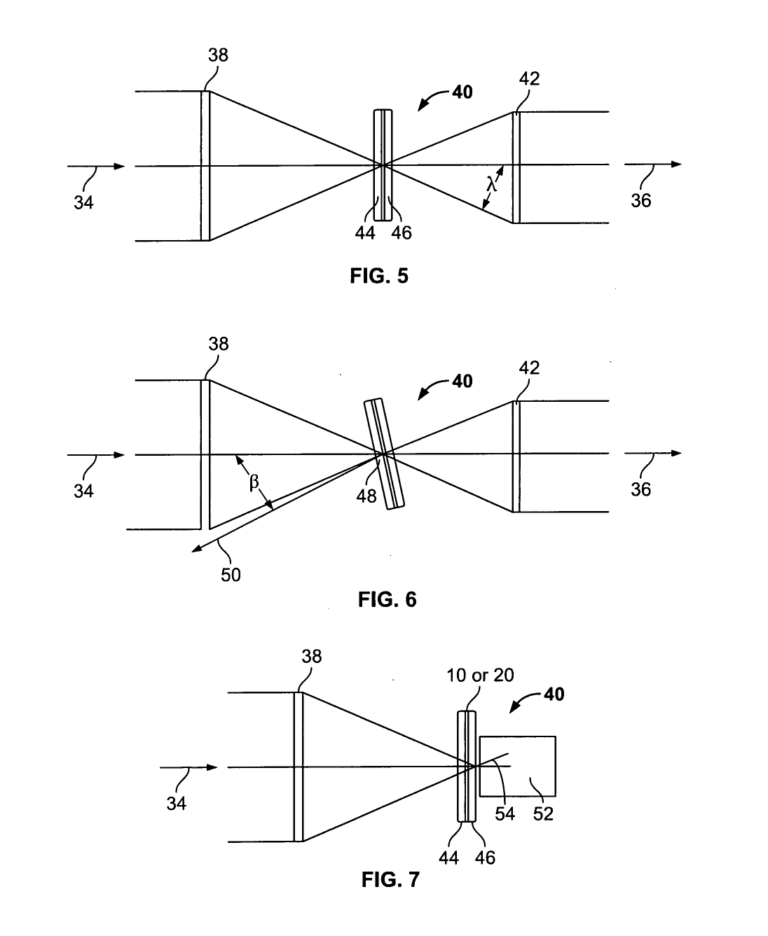

FIG. 5. illustrates a free space optical grating like limiter, Type 1 or 2, in which light enters from the left side as a prime incident ray 34. The incident light is focused by a condensing lens 38 onto the optical limiting solid grating assembly 40. Optional entrance and exit windows 44 and 46 are shown with the optical limiting solid grating 10, Type 1, or 20, Type 2, sandwiched in between, forming the assembly 40. The exit ray 36 represents the limited optical output when the input light power is below the threshold. Above threshold power, the beam is back reflected, partially or totally, and the limiting action is achieved. This limiter functions well in the forward direction and limits the output light 36, but the back reflected light can be troublesome. FIG. 6. is a variation of the embodiment shown in FIG. 5 in which the optical limiting assembly 40 is placed at an angle β/2 so that reflected light 50 from the limiting mechanism does not re-enter the optical system.

FIG. 7. illustrates a free space optical grating like limiter, Type 1 or 2, in front of a camera or light sensor 52 in which light enters from the left side as a prime incident ray 34. The incident light is focused by a lens 38 onto the optical limiting solid grating assembly 40 in front of the camera or sensor 52. Optional entrance and exit windows 44 and 46 are shown with the optical limiting solid grating 10, Type 1, or 20, Type 2, sandwiched in between, forming the assembly 40. The assembly 40 can be part of the sensor 52, thus omitting window 46, or placed in the proximity of the sensor 52 (about 1 to 3 mm away from the sensor). The exit ray 54 represents the limited optical output when the input light power is below the threshold. Above threshold power, the beam is back reflected, partially or totally, and the limiting action is achieved.

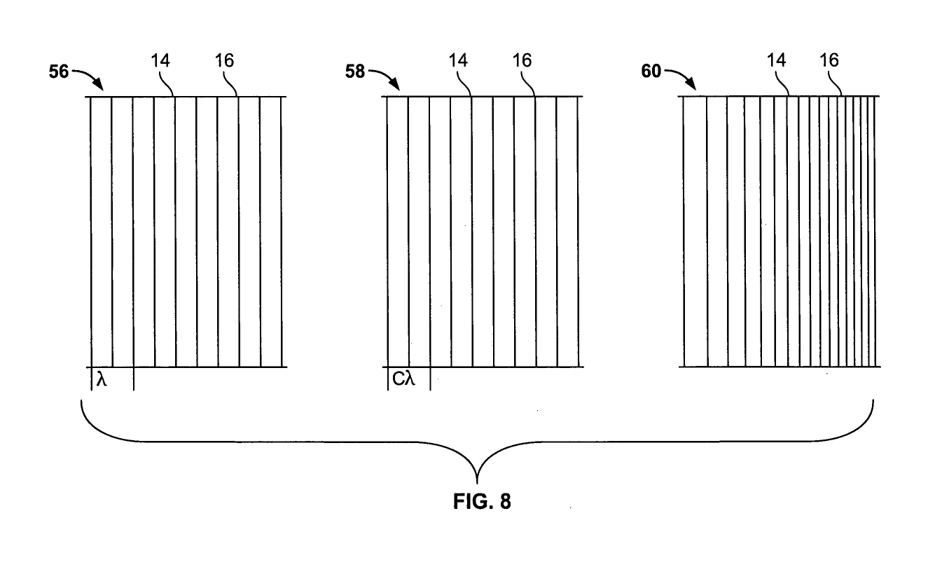

FIG. 8. illustrates three kinds of gratings: 56 for perpendicular impingement, where the period is λ, single wavelength; 58 for angled impingement, where the period is a constant times λ, according to the impingement angle and the single wavelength; and 60, a chirped, period changing, grating, for wideband (a range of wavelengths) impinging light reflection

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A reversible optical energy limiting device, comprising a waveguide forming an optical path between an input end and an output end, and an optical energy responsive material located in said optical path for reflecting at least a portion of the optical energy received from said input end back toward said input end when said optical energy exceeds a predetermined threshold,
said optical energy responsive material comprising an optical power limiting grating which undergoes reversible thermal changes when subjected to optical energy above said predetermined threshold,
said optical power limiting grating comprising multiple alternating layers of transparent dielectric material and multiple intervening layers that include small light absorbing particles dispersed in an optically transparent matrix material.

2. (canceled)

3. (canceled)

4. The reversible optical energy limiting device of claim 1 in which said intervening layers comprise a thin, nanometer-thickness, partially-light-absorbing material.

5. The reversible optical energy limiting device of claim 1 in which said optical energy responsive material does not reflect optical energy when subjected to optical energy below said predetermined threshold.

6. The reversible optical energy limiting device of claim 1 in which said intervening layers have an index of refraction that decreases as light is absorbed by said material.

7. The reversible optical energy limiting device of claim 1 in which said optical energy responsive material extends across said optical path an acute angle relative to the longitudinal axis of said optical path.

8. The reversible optical energy limiting device of claim 1 in which said alternating layers of transparent dielectric material are transparent to optical energy below said predetermined threshold, and reflect at least a portion of all energies above said predetermined threshold.

9. The reversible optical energy limiting device of claim 1 in which said energy responsive material comprises a suspension of light absorbing particles in a solid material.

10. The reversible optical energy limiting device of claim 8 in which said absorbing particles are nano particles of at least one material selected from the group consisting of Ag, Au, Ni, Va, Ti, Co, Cr, C, Re, Si, SmO₂ and mixtures thereof.

11. The reversible optical energy limiting device of claim 8 in which said solid material is at least one transparent material selected from the group consisting of PMMA, derivatives of PMMA, epoxy resins, glass and SOG.

12. The reversible optical energy limiting device of claim 1 in which said optical limiting solid grating is placed in an optical system of limited numerical aperture.

13. The reversible optical energy limiting device of claim 1 in which said optical power limiting solid grating is packaged between the ferrule tips of two physical contact mated connectors.

14. The reversible optical energy limiting device of claim 1 in which said optical limiting solid grating is packaged between two bare fibers, in line.

15. The reversible optical energy limiting device of claim 14 in which an end face of each said bare fibers is angled to reduce back reflection.

16. The reversible optical energy limiting device of claim 1 in which said optical limiting solid grating is placed in or near the focus of an optical system of two lenses, having a cross over.

17. The reversible optical energy limiting device of claim 1 in which said optical limiting solid grating is placed in or near the focus of a camera sensor.

18. The reversible optical energy limiting device of claim 1 in which said optical limiting solid grating is chirped to reflect a wide range of wavelengths.

19. A method of controlling the propagation of optical energy along an optical path between an input end and an output end of an optical waveguide, said method comprising reflecting at least a portion of the optical energy propagated from said input end toward said output end, back toward said input end in response to an increase in said optical energy to a predetermined threshold, and automatically resuming the propagation of said optical energy to said output end in response to a decrease in said optical energy below said predetermined threshold.

20. The method of claim 19 in which said optical energy is reflected by a light-absorbing material having an index of refraction that decreases as light is absorbed by said material.
